(19) United States
(12) Patent Application Publication
(10) Pub. No.: US 2019/0161613 A1
(43) Pub. Date: May 30, 2019

(54) SINGLE COMPONENT SYSTEM

(71) Applicant: Hexion Inc., Columbus, OH (US)

(72) Inventors: Matthew SUMPTER, Richmond, TX (US); Yukun LI, Missouri City, TX (US)

(73) Assignee: Hexion Inc.

(21) Appl. No.: 15/825,931

(22) Filed: Nov. 29, 2017

(51) Int. Cl. C08L 83/04; C08L 63/00; C09D 163/00; C09D 183/04

(52) U.S. Cl. CPC C08L 83/04; C09D 183/04; C09D 163/00; C08L 63/00

(57) ABSTRACT

A composition comprising a) an epoxy resin; b) a silicone resin; and c) an organosilane coupling agent having at least one protecting functional group, is disclosed. The composition can be used for coating applications.

### FIELD OF THE INVENTION

This invention relates to coating compositions. More particularly, this invention relates to coating compositions that are single component systems.

### BACKGROUND OF THE INVENTION

Many high performance coatings, adhesives, and sealants known in the art include resin systems based on epoxies and silicone resins. Silicone resins can improve several properties of epoxy coatings including, for example, chemical resistance, UV resistance, thermal resistance, coating hardness, and coating flexibility. However, many of these systems are supplied as two separate components, commonly referred to as ‘2K systems’. In 2K systems, one of the components is a resin and the second component is a curing agent. The components are mixed together just before application to a substrate.

These systems are employed in a variety of applications including coatings, adhesives, laminates, and composites. Epoxy and epoxy-silane resin systems are used in a wide variety of functional and decorative applications including corrosion resistant coatings for underground pipe and steel reinforcing bars, electrical insulating coatings, appliance coatings, and finishes for automotive parts. These compositions offer good adhesion, hardness and impact resistance as well as protection from a variety of chemical and corrosive environments. However, these compositions may show loss of performance or appearance when exposed to UV radiation, weathering, or when utilized under hot, wet, conditions. Also, in the case of 2K systems, they can have poor performance and/or appearance when not mixed properly before application and also have limited working times as they tend to gel fairly quickly.

To provide a simpler, more “user friendly” application process, single component systems (also known as ‘1K systems’) have been developed. These systems do not need to be mixed with another component before applying to a substrate in order to cure. Single component systems have an indefinite pot life in a closed container, and only cure after they are applied to a substrate at ambient conditions. There are many types of single component systems, but most have drawbacks. Acrylic systems do not have good chemical resistance or the adhesion of epoxy systems. Urethane systems are often not suitable for primer applications and are manufactured with isocyanates, which can pose a health risk. Alkyd systems can be susceptible to chemical attack and transesterification.

Therefore, a system having the performance of an epoxy-silicone resin system and also having the convenience of a one-component system would be desirable.

### SUMMARY OF THE INVENTION

In one broad embodiment of the present invention, there is disclosed a composition comprising, consisting of, or consisting essentially of: a) an epoxy resin; b) a silicone resin; and c) an organosilane coupling agent having at least one protecting functional group.

### DETAILED DESCRIPTION OF THE INVENTION

The composition of the present invention comprises, consists of, or consists essentially of a) an epoxy resin, b) a silicone resin, and c) an organosilane coupling agent having at least one protecting functional group. In various embodiments, the composition is present as a single component system. As used herein, the terms ‘single component system,’ ‘one-component system,’ and ‘1K system’ denote compositions where all of the components are present and are stored in a single container. The composition of the present invention is also storage stable, which means that the composition remains in liquid form suitable for application, for a period of at least six months in the original closed container.

In various embodiments, the epoxy resins utilized in the compositions of the present invention include those resins produced from an epihalohydrin and a polyhydric phenol. The polyhydric phenol includes compounds having an average of more than one aromatic hydroxyl group per molecule. Examples of polyhydric phenol compounds include dihydroxy phenols, biphenols, bisphenols, halogenated biphenols, hydrogenated bisphenols, alkylated biphenols, alkylated bisphenols, trisphenols, phenol-aldehyde resins, novolac resins (the reaction product of phenols and simple aldehydes, such as formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof. Specifically, polyhydric phenol compounds include resorcinol, catechol, hydroquinone, bisphenol A, bisphenol AP (1,1-bis(4-hydroxyphenyl)-1-phenyl ethane), hydrogenated bisphenol A, bisphenol F, hydrogenated bisphenol F, bisphenol K, tetrabromobisphenol A, phenol-formaldehyde novolac resins, alkyl substituted phenol-formaldehyde resins, cresol-hydroxybenzaldehyde resins, dicyclopentadiene-phenol resins, dicyclopentadiene-substituted phenol resins, tetramethylbiphenol, tetramethyl-tetrabromobiphenol, tetramethyltribromobiphenol, and tetrachlorobisphenol A. In various embodiments, the epoxy resin is derived from a bisphenol or a hydrogenated bisphenol.

Examples of commercially available epoxy resins include, but are not limited to EPON™ Resins 825, 826, 828, 862, and 1001, and EPONEX™ 1510, 1511, available from Hexion Inc., and D.E.R.™ resins 301, 317, 321, 3212, 322, 3221, 323, and 324, available from Olin.

In various embodiments, the silicone resin has a structure as depicted by Formula I, below:

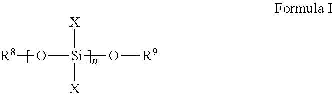

In the structure above, each X is independently a methoxy group, an ethoxy group, a methyl group, a phenyl group, or —OSi(OX)₃, wherein X is as described previously, with the proviso that the silicone resin contains less than 16 silicon atoms. Additional Si(OX)₃ groups can give the structure a three-dimensional nature. R⁸ and R⁹ are each independently an alkyl group having from 1 to 6 carbon atoms, a hydroxy group, an aryl group having from 2 to 6 carbon atoms, an alkoxy group having from 1 to 6 carbon atoms, or an epoxy group. Also, n is from 1 to 12. Any and all ranges between 1 and 12 are included herein and disclosed herein; for example, n can be in the range of from 1 to 10, from 2 to 8, from 2 to 6, or from 2 to 3.

Examples of silicone resins which are commerically available include, but are not limited to KC-89S, KR-515, KR-500, X-40-9225, X-40-9246, X-40-9250, KR-401N, X-40-9227, KR-510, KR-9218, and KR-213, all available from Shin-Etsu Silicones of America, Inc., and XC96-B0446, XR31-B1410, XR31-B2733, XR-31-B2230, TSR165, XR31-B6667, XR31-B1763, XC96-C2813, and XC96-2814, all available from Momentive Performance Materials Inc, and DC 3034, DC 3037, and DC 3074, available from Dow Corning.

The silicone resin generally does not react with the epoxy compound while they are present together in a container.

The epoxy resin is generally present in the composition in an amount in the range of from 10 weight percent to 75 weight percent, based on the total weight of the composition. Any and all weight percents between 10 and 75 weight percent are included herein and disclosed herein; for example, the epoxy resin can be present in an amount in the range of from 15 to 65 weight percent, or from 15 to 55 weight percent, or from 20 to 45 weight percent.

The silicone resin is generally present in the composition in an amount in the range of from 10 weight percent to 50 weight percent, based on the total weight of the composition. Any and all weight percents between 10 and 50 weight percent are included herein and disclosed herein; for example, the silicone resin can be present in an amount in the range of from 15 to 45 weight percent, or from 18 to 40 weight percent, or from 20 to 35 weight percent.

The composition also contains an organosilane coupling agent which has a protecting group. The protecting group is a functional group which blocks specific reactions under specific conditions. In various embodiments, the protecting group in the organosilane coupling agent blocks the epoxy/amine reaction under certain conditions, such as, for example, exposure to moisture.

In various embodiments, the silane-containing coupling agent is a ketiminosilane. The ketiminosilane contains both a ketimine group and at least one silicon atom. A ketimine group is typically formed by a condensation reaction between a compound containing a primary amino group and a compound containing a ketone group. The ketiminosilane can generally be represented by Formula II, below:

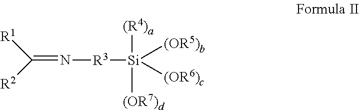

In the above Formula II, R¹ is an intermediate or linking hydrocarbon group such as an alkyl group having from 1 to 16 carbon atoms, a cycloaliphatic group having from 4 to 8 carbon atoms, an aromatic group having from 6 to 15 carbon atoms, or an alkyl substituted aromatic group having from 6 to 15 carbon atoms. R² can be an alkyl group having from 1 to 25 carbon atoms, an aromatic group having from 6 to 15 carbon atoms, or an alkyl substituted aromatic group having from 6 to 15 carbon atoms. Also in Formula II, a is from 0 to 2 and b, c, and d are each from 0 to 1, with the proviso that a+b+c+d=3. R³, R⁴, and R⁵ are each independently an alkyl group having from 1 to 10 carbon atoms, an aromatic group having from 6 to 12 carbon atoms, or an alkyl substituted aromatic group having from 6 to 12 carbon atoms. R⁶ and R⁷ are each independently an alkyl group having from 1 to 4 carbon atoms, an aromatic group having from 6 to 15 carbon atoms, or an alkyl substituted aromatic group having from 6 to 15 carbon atoms.

In Formula II above, the protecting group is the ketimine group.

Commercially available examples of organosilane coupling agents include, but are not limited to X-12-1172ES, X-12-1056ES, KBE-9103P, and X-12-967C, all available from Shin Etsu Silicones of America, Inc., and VPS 1262, available from Evonik.

The organosilane coupling agent is generally present in the composition in an amount in the range of from 10 weight percent to 75 weight percent, based on the total weight of the composition. Any and all weight percents between 10 and 75 weight percent are included herein and disclosed herein; for example, the organosilane coupling agent can be present in an amount in the range of from 15 to 65 weight percent, or 20 to 55 weight percent, or 35 to 50 weight percent.

In various embodiments, the epoxy resin, the silicone resin, and the organosilane coupling agent are also present in an amount such that the composition has a molar ratio of epoxy groups to amine groups in the range of from 1:0.3 to 1:2. Any and all molar ratios of epoxy groups to amine groups between 1:0.3 to 1:2 are included herein and disclosed herein, for example, the epoxy resin, the silicone resin, and organosilane coupling agent can be present in amount such that the composition has a molar ratio of epoxy groups to amine groups in the range of from 1:0.5 to 1:1.75, from 1:0.75 to 1:1.5, or from 1:1 to 1:1.35.

Flexibilizers can optionally be added to the composition. Flexibilizers can vary the characteristics of cured compositions for various applications. For example, employing a flexibilizer can help provide that the cured composition is less brittle than a cured composition that does not contain the flexibilizer.

Optionally, a catalyst can be used to accelerate curing of the composition.

Suitable catalysts include, but are not limited to metal alkoxides, such as titanium tetraisopropoxide, aluminum triethoxide and zirconium tetrabutoxide, organic tin compounds, such as dibutyl tin dilaurate, dibutyl tin diacetate, and dibutyl tin bis(2-ethylhexoate), alkaline catalysts such as potassium hydroxide and sodium hydroxide, organic acids, inorganic acids, tertiary amines, and mixtures thereof.

Pigments can also optionally be used in the composition. Examples of pigments that can be used include, but are not limited to titanium dioxide, red iron oxide, yellow iron oxide, carbon black, copper phthalocyanine blue, sodium aluminum sulphosilicate, chromium oxide, cobalt chromite green spinel, chromium green-black hematite, nickel antimony titanium yellow rutile, and manganese-based pigments.

Various other optional compositions that can be present include, but are not limited to solvents, diluents, corrosion inhibitors, defoamers, additives, and fillers.

The compositions disclosed herein can be used in a variety of applications including, but not limited to a coating, an adhesive, a sealant, or as a component of a composite material. More specifically, the compositions can be employed as primers for metal surfaces, architectural or industrial coatings, pipeline coatings, structural adhesives, or tank linings.

### EXAMPLES

### Example 1

50 parts by weight of EPON™ 828 (available from Hexion Inc.) was blended with 50 parts by weight of DC 3074 (available from Dow Corning) and 60 parts by weight of KBE-9103P (available from Shin-Etsu Silicones of America, Inc.), a ketiminosilane, to form a mixture. The mixture was placed in a jar and was stirred overnight on a roller mill.

### Example 2

A two component clearcoat mixture was prepared in the following manner: 50 parts by weight of EPON ™828 was mixed with 50 parts by weight of DC 3074 and 30.8 parts by weight of (3-aminopropyl)triethoxysilane for about 10 minutes before testing.

The two coating compositions underwent several tests. Table 1, below, shows the test methods and results for the compositions, which were both tested 7 days after preparation.

TABLE 1
Tests and Results of Coating Compositions

| | | Value | |
|---|---|---|---|
| | | Example 1: 1K | Example 2: 2K |
| | | Clearcoat | Clearcoat |
| Test | | (TESTED @ 7 | (TESTED @ 7 |
| Method | Description | DAYS) | DAYS) |
| ASTM D5895 | Dry-through Time | 8 | 6.5 |
| | (hr) | | |
| ASTM D1186 | Pencil Hardness | 2H | 2H |
| ASTM D4366 | König Hardness | 192 | 203 |
| | (sec) | | |
| ASTM D3359 | X-cut Adhesion | 4A | 4A |
| ASTM D5402 | MEK Resistance | >200 | >200 |
| | (DRs) | | |
| ASTM D523 | 60° Gloss (GU) | 100 | 100 |

As can be seen in Table 1, above, the 1K system has comparable properties to the 2K system.

While the present invention has been described and illustrated by reference to particular embodiments and examples, those of ordinary skill in the art will appreciate that the invention lends itself to variations not necessarily illustrated herein.

1. A composition comprising:
a) an epoxy resin;
b) a silicone resin; and
c) an organosilane coupling agent having at least one protecting functional group.

2. A composition in accordance with claim 1 wherein the organosilane coupling agent has a structure of 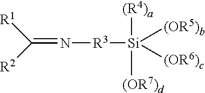
wherein R¹ is an alkyl group having from 1 to 16 carbon atoms, a cycloaliphatic group having from 4 to 8 carbon atoms, an aromatic group having from 6 to 15 carbon atoms, or an alkyl substituted aromatic group having from 6 to 15 carbon atoms, R² is an alkyl group having from 1 to 25 carbon atoms, an aromatic group having from 6 to 15 carbon atoms, or an alkyl substituted aromatic group having from 6 to 15 carbon atoms,
a is from 0 to 2;
b, c, and d are each from 0 to 1, with the proviso that a+b+c+d=3;
R³, R⁴, and R⁵ are each independently an alkyl group having from 1 to 10 carbon atoms, an aromatic group having from 6 to 12 carbon atoms, or an alkyl substituted aromatic group having from 6 to 12 carbon atoms; and
R⁶ and R⁷ are each independently an alkyl group having from 1 to 4 carbon atoms, an aromatic group having from 6 to 15 carbon atoms, or an alkyl substituted aromatic group having from 6 to 15 carbon atoms.

3. A composition in accordance with claim 1 wherein the silicone resin has a structure of 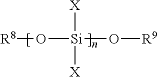
wherein each X is independently a methyl group, a methoxy group, an ethyl group, an ethoxy group, a methyl group, a phenyl group, or —OSi(OX)3;
wherein R⁸ and R⁹ are each independently an alkyl group having from 1 to 6 carbon atoms, a hydroxyl group, an aryl group having from 2 to 6 carbon atoms, an alkoxy group having from 1 to 6 carbon atoms or an epoxy group; and
wherein n is from 1 to 12
with the proviso that the silicone resin contains less than 16 silicon atoms.

4. A composition in accordance with claim 1 wherein the composition is in the form of a single component system.

5. A composition in accordance with claim 1 wherein the epoxy resin is derived from a bisphenol or a hydrogenated bisphenol.

6. A composition in accordance with claim 1 wherein the epoxy resin, the silicone resin, and the ketiminosilane coupling agent are present in an amount such that the composition has a molar ratio of epoxy groups to amine groups in the range of from 1:0.3 to 1:2.

7. A composition in accordance with claim 1 wherein the epoxy resin is present in an amount in the range of from 10 weight percent to 75 weight percent, based on the total weight of the composition.

8. A composition in accordance with claim 1 wherein the silicone resin is present in an amount in the range of from 10 weight percent to 50 weight percent, based on the total weight of the composition.

9. A composition in accordance with claim 1 wherein the ketiminosilane coupling agent is present in an amount in the range of from 10 weight percent to 75 weight percent, based on the total weight of the composition.

10. A composition in accordance with claim 1, further comprising a catalyst.

11. A composition in accordance with claim 1, further comprising a compound selected from the group consisting of flexibilizers, solvents, diluents, corrosion inhibitors, additives, pigments, defoamers, and combinations thereof.
